(19) United States
(12) Patent Application Publication
(10) Pub. No.: US 2006/0192450 A1
(43) Pub. Date: Aug. 31, 2006

(54) Heat dissipating fan assembly

(76) Inventor: Hsin-Mao Hsieh, Pingtung City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/068,630

(22) Filed: Feb. 28, 2005

(51) Int. Cl. H02K 9/06

(52) U.S. Cl. 310/90; 310/63

(57) ABSTRACT

A heat dissipating fan assembly includes a frame provided with multiple ventilation holes, a sleeve on top of a bottom face defining the receiving space and having a connection hole and two opposed retainers formed on a top peripheral edge of the sleeve, a bearing, a stator securely mounted around the sleeve and having a coil set mounted on a circuit board and a rotor having a hollow casing, multiple blades formed on an outer periphery of the hollow casing and a bearing shaft hole defined in a bottom face of the hollow casing to securely receive therein the bearing shaft, the bearing shaft hole having a mediate portion provided with a diameter larger than that of the bearing shaft such that extension of the bearing shaft into the bearing shaft hole reduces possibility of damage to the bearing shaft.

### BACKGROUND OF THE INVENTION

1. Field of the Invention

The present invention relates to a heat dissipating fan assembly, and more particularly to a heat dissipating fan assembly having a rotor provided with an assembly hole which at a mediate portion thereof has an inner diameter larger than an outer diameter of a bearing shaft extending from a top face of a bearing such that due to the non-engagement relationship between the bearing and the rotor, rotational noise between the rotor and the bearing is low.

2. Description of Related Art

It is widely accepted that using a cooling fan in electronic appliances greatly helps maintain the operational efficiency of the electronic appliances because heat generated from the electronic appliances impedes their performance. Accordingly, cooling fans have become standard equipment in the electronic appliances. However, irritating noises are often generated by such fans due spinning of a rotor in a bearing. That is, the conventional cooling fan includes either a ball bearing or a self-lubrication bearing and both of them have different problems. The ball bearing includes multiple balls rotatably received inside the bearing casing. When the bearing is used, the balls rotating inside the bearing casing will be gradually worn due to friction with the inner sidewall of the bearing casing. This wear leads to noise during operation of the appliance. The self-lubrication bearing does have lower noise than that of the ball bearing due to the addition of lubrication oil, but the lubrication oil loss during the operation over the time becomes the major drawback to this type of bearing. That is, dryness of the bearing causes friction and corresponding noise.

To overcome the shortcomings, the present invention tends to provide an improved heat dissipating fan assembly to mitigate the aforementioned problems.

### SUMMARY OF THE INVENTION

The primary objective of the present invention is to provide a heat dissipating fan assembly to achieve low-noise operation.

In one aspect of the present invention, a bearing shaft is rotatably provided inside the hollow cylindrical portion and extending out of the cylindrical portion such that when the bearing shaft is connected to the rotor, the integrity of the rotor is maintained.

In yet another aspect of the present invention, the base of the heat dissipating fan assembly has a sleeve formed on a bottom face of the base and defines therein a connection hole to receive the cylindrical portion and two opposed hooks formed on a top periphery of the sleeve to abut a top face of the cylindrical portion so that the cylindrical portion is securely connected to the base of the heat dissipating fan assembly.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the heat dissipating fan assembly of the present invention;

FIG. 2 is a cross sectional view of the heat dissipating fan in assembly;

FIG. 3 is an exploded cross sectional view of a different embodiment of the heat dissipating fan assembly of the present invention; and

FIG. 4 is a cross sectional view of the assembled heat dissipating fan assembly in FIG. 3.

### DETAILED DESCRIPTION OF THE PREFERRED EMBODIMENT

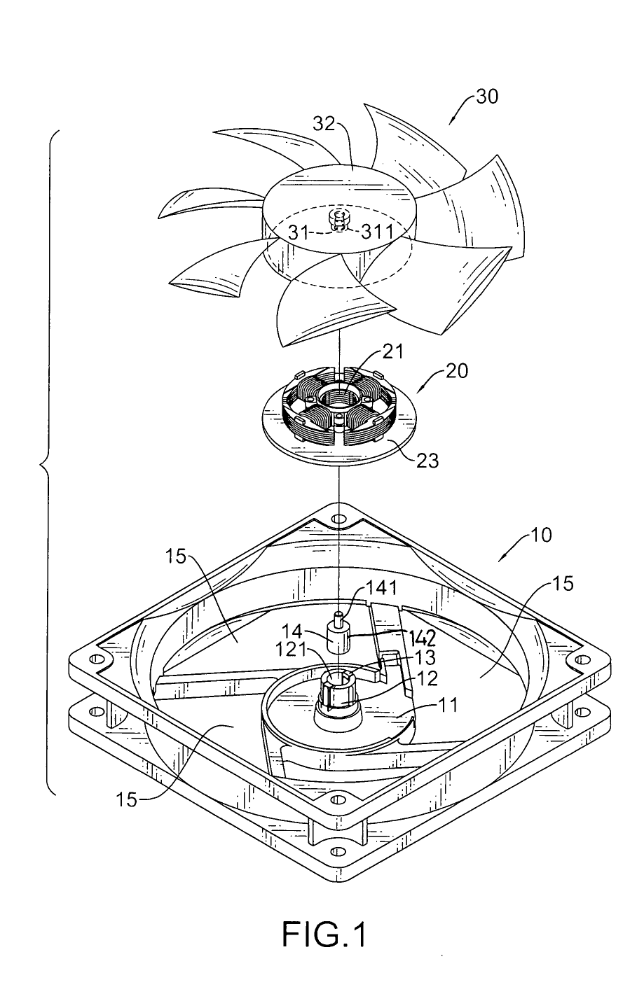

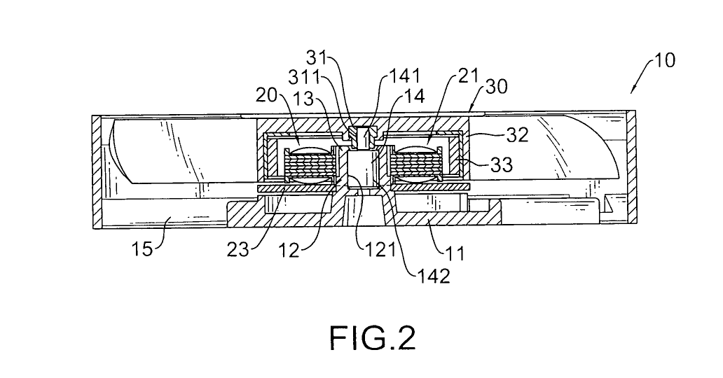

With reference to FIGS. 1 and 2, it is noted that the heat dissipating fan assembly in accordance with the present invention includes a frame (10), a stator (20) and a rotor (30).

The frame (10) is provided with a receiving space (not numbered) and a sleeve (12) is formed on a bottom face (11) of the receiving space. The sleeve (12) defines therein a connection hole (121) and has two opposed hooks (13) formed on a top periphery of the connection hole (121). Ventilation holes (15) are defined through the bottom face (11) of the frame (10) to communicate with the receiving space of the frame (10). Further, a bearing (fluid dynamic bearing; FDB) (14) is provided to the heat dissipating fan assembly of the present invention. The bearing (14) includes a hollow cylindrical portion (142) and a bearing shaft (141) extending out of the cylindrical portion (142) and rotatably received inside the cylindrical portion (142). Further, grease is provided between the cylindrical portion (142) and the bearing shaft (141) to allow the bearing shaft (141) to rotate freely without interference from the cylindrical portion (142).

The stator (20) is mounted outside the sleeve (12) and includes a coil set (21) which is mounted on top of a circuit board (23).

The rotor (30) includes a casing (32) with an open end and a closed end. Multiple blades (not numbered) are securely and firmly attached to a peripheral wall of the casing (32). A bearing shaft hole (31) is defined in a bottom face defining the closed end of the casing (32) to correspond to and receive therein the bearing shaft (141). A mediate portion (311) of the bearing shaft hole (31) has a diameter larger than that of a diameter of the bearing shaft (141). A magnet (33) is provided and formed inside the casing (32).

After the heat dissipating fan of the present invention is assembled, it is noted that the cylindrical portion (142) of the bearing (14) is received in the connection hole (121) of the sleeve (12) and the bearing shaft (141) is extended into the bearing shaft hole (31) of the rotor (30) after the stator (20) is mounted around the sleeve (12) to have the coil set (21) corresponded to the magnet (33) of the rotor (30). Thus after the coil set (21) is energized to generate a magnetic field which is opposite to that of the magnet (33) of the rotor (30), the rotor (30) is pushed by the magnetic field to rotate. It is noted that because the diameter of the mediate portion (311) of the bearing shaft hole (31) is larger than that of the bearing shaft (141), extension of the bearing shaft (141) into the bearing shaft hole (31) reduces the possibility of damage to the bearing shaft (141) as well as the rotor (30).

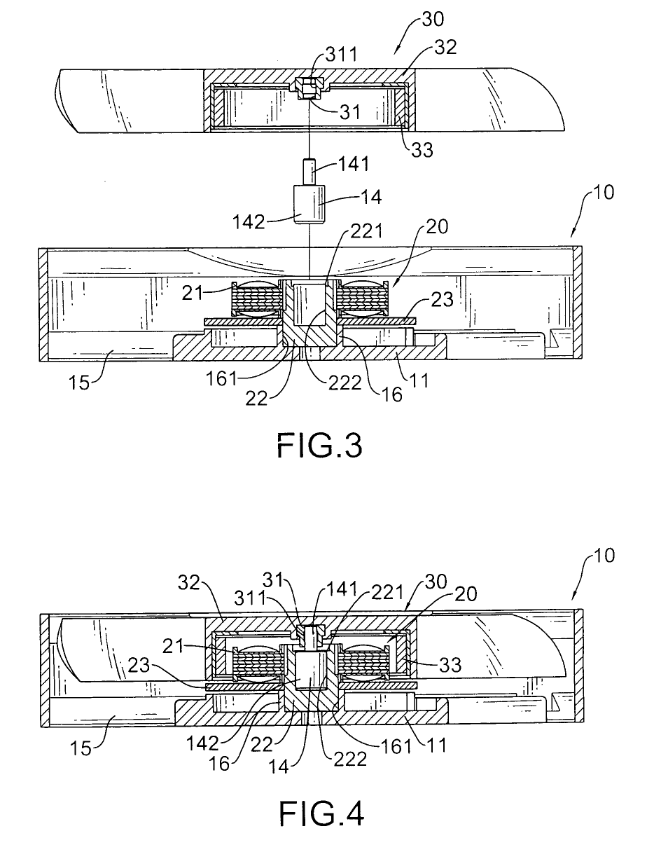

With reference to FIGS. 3 and 4, the heat dissipating fan assembly in accordance with the present invention includes a frame (10), a stator (20) and a rotor (30).

The frame (10) is provided with a receiving space (not numbered) and a sleeve seat (16) is formed on a bottom face (11) of the receiving space. The sleeve seat (16) defines therein a sleeve hole (161) to receive a sleeve (22). The sleeve (22) has a connection hole (222) and has two opposed hooks (221) formed on a top periphery of the connection hole (222). Ventilation holes (15) are defined through the bottom face (11) of the frame (10) to communicate with the receiving space of the frame (10). Further, a bearing (fluid dynamic bearing; FDB) (14) is provided to the heat dissipating fan assembly of the present invention. The bearing (14) includes a hollow cylindrical portion (142) and a bearing shaft (141) extending out of the cylindrical portion (142) and rotatably received inside the cylindrical portion (142). Further, grease is provided between the cylindrical portion (142) and the bearing shaft (141) to allow the bearing shaft (141) to rotate freely without interference from the cylindrical portion (142).

The stator (20) is mounted outside the sleeve (12) and includes a coil set (21) which is mounted on top of a circuit board (23).

The rotor (30) includes a casing (32) with an open end and a closed end. Multiple blades (not numbered) are securely and firmly attached to a peripheral wall of the casing (32). A bearing shaft hole (31) is defined in a bottom face defining the closed end of the casing (32) to correspond to and receive therein the bearing shaft (141). A mediate portion (311) of the bearing shaft hole (31) has a diameter larger than that of a diameter of the bearing shaft (141). A magnet (33) is provided and formed inside the casing (32).

After the heat dissipating fan of the present invention is assembled, it is noted that the cylindrical portion (142) of the bearing (14) is received in the connection hole (222) of the sleeve (22) and the bearing shaft (141) is extended into the bearing shaft hole (31) of the rotor (30) after the stator (20) is mounted around the sleeve (22) to have the coil set (21) corresponded to the magnet (33) of the rotor (30). Thus after the coil set (21) is energized to generate a magnetic field which is opposite to that of the magnet (33) of the rotor (30), the rotor (30) is pushed by the magnetic field to rotate. It is noted that because the diameter of the mediate portion (311) of the bearing shaft hole (31) is larger than that of the bearing shaft (141), extension of the bearing shaft (141) into the bearing shaft hole (31) reduces the possibility of damage to the bearing shaft (141) as well as the rotor (30).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A heat dissipating fan assembly comprising:
a frame defining therein a receiving space and provided with multiple ventilation holes in communication with the receiving space and a sleeve on top of a bottom face defining the receiving space and having a connection hole defined in the sleeve and two opposed retainers formed on a top peripheral edge of the sleeve;
a bearing having a cylindrical portion securely received in the connection hole of the sleeve to be abutted by the retainers and a bearing shaft rotatably received in and extending out of the cylindrical portion;
a stator securely mounted around the sleeve and having a coil set mounted on a circuit board; and
a rotor having a hollow casing, multiple blades formed on an outer periphery of the hollow casing having a bottom face, with a bearing shaft hole defined in the hollow casing and extending from the bottom face to securely receive therein the bearing shaft, the bearing shaft hole having a first, outer portion, a second, mediate portion and a third, inner portion, with the second portion located intermediate the first and third portions and the first portion located intermediate the second portion and the bottom face, with the second portion spaced from the bottom face, with the second portion provided with a diameter larger than that of the bearing shaft and of diameters of the first and third portions, with the diameters of the first and third portions corresponding to and receiving the diameter of the bearing shaft, with the diameter of the bearing shaft being uniform within the first, second and third portions of the bearing shaft hole, such that extension of the bearing shaft into the bearing shaft hole reduces possibility of damage to the bearing shaft.

2. The heat dissipating fan as claimed in claim 1, wherein grease is provided between the cylindrical portion and the bearing shaft to allow the bearing shaft to rotate freely.

3. The heat dissipating fan as claimed in claim 2, wherein the retainers are hooks such that the hooks are able to abut a top face of the cylindrical portion of the bearing to retain the bearing inside the connection hole.

4. The heat dissipating fan as claimed in claim 1 further comprising a sleeve seat formed on the bottom face of the frame and defining therein a sleeve hole to securely receive therein the sleeve.

5. The heat dissipating fan as claimed in claim 2 further comprising a sleeve seat formed on the bottom face of the frame and defining therein a sleeve hole to securely receive therein the sleeve.

6. The heat dissipating fan as claimed in claim 3 further comprising a sleeve seat formed on the bottom face of the frame and defying therein a sleeve hole to securely receive therein the sleeve.
